(19) United States
(12) Patent Application Publication
(10) Pub. No.: US 2022/0245773 A1
(43) Pub. Date: Aug. 4, 2022

(54) BURN-IN REMOVAL FROM FULL MOTION VIDEO IMAGERY FOR VIDEO EXPLOITATION

(71) Applicant: BAE SYSTEMS Information and Electronic Systems Integration Inc., Nashua, NH (US)

(72) Inventors: Sowmya RAMAKRISHNAN, Kendall Park, NJ (US); AMY von HOLTEN, Billerica, MA (US)

(73) Assignee: BAE SYSTEMS Information and Electronic Systems Integration Inc., Nashua, NH (US)

(21) Appl. No.: 17/162,988

(22) Filed: Jan. 29, 2021

(51) Int. Cl. G06T 5/00; G06T 5/30; H04N 5/21

(52) U.S. Cl. CPC G06T 5/005; G06T 5/30; G06T 2207/10024; G06T 2207/10016; H04N 5/21

(57) ABSTRACT

The system and method of removing burn-in from full motion video (FMV) imagery. In some cases, the technique is a pre-processing step in a forensic or military application. The system and method identify one or more burn-in overlay areas in a full motion video image and creates a mask of the one or more burn-in overlay areas. Matched intensities are created for a plurality of pixels in a mask. In some cases, in-painting is used in a center portion of the full motion video image and order-filtering in used on a periphery of the full motion video image to create the matched intensities.

### STATEMENT OF GOVERNMENT INTEREST

This disclosure was made with United States Government support under Contract No. W56KGU-15-D-0007 under the Technical Information Engineering Services (TIES) Subcontract No. S18-10080, awarded by the U.S. Army Communications-Electronics Research Development and Engineering Center (CERDEC). The United States Government has certain rights in this invention.

### FIELD OF THE DISCLOSURE

The present disclosure relates to full motion video (FMV) imagery processing and more particularly to a burn-in removal technique for full motion video imagery for use in further video exploitation pipelines useful for threat detection, automatic target recognition, and the like.

### BACKGROUND OF THE DISCLOSURE

Nearly all operational full motion video (FMV) has burn-in present that incorporates metadata into the imagery. In some examples, sensor metadata such as location co-ordinates (latitude/longitude/altitude), platform yaw/pitch/roll and other user-interface/geo-spatial data are burned-in as overlays on FMV imagery as part of the video acquisition process. In certain embodiments, burn-ins may include any or a subset of the following overlays on the acquired image: (i) collection metadata such as dates, timestamps, frame numbers, location, (ii) sensor metadata such as modality, Field-Of-View (FOV), Line Of Sight (LOS), (iii) User-Interface (UI) data such as cross-hairs, focus-region, mode of operation (e.g., auto/manual) etc., (iv) geo-spatial data such as scales, North direction marker and/or arrow, (v) readings from Inertial Navigation System (INS), telemetry/radar systems, gyro meter, accelerometer, system error indicators and the like.

Automatic target detection, tracking and recognition algorithms are challenged to process these videos having burned-in sensor meta-data and other UI/geo-spatial data due the clutter introduced by these overlays. Presence of burn-ins adversely affects frame-to-frame registration during automated video exploitation of FMV imagery. Frame-to-frame registration aids in moving target detection, the main basis for many tracking algorithms. Frame-to-frame registration to correct apparent camera motion (jitter) extracts feature points from the current frame and corresponding feature points at neighboring image areas in the previous frame. Matching these feature points in successive frames aligns the frames to one another. Burn-ins tend to have large amount of text and numbers overlaid on the image, whose image edges/corners trigger numerous spurious feature points. This causes the frames to align primarily based on the feature points from burn-ins rather than from actual image features. Thus, the burn-ins corrupt the alignment of successive frames i.e., inter-frame homography. Thus, burn-ins are an impediment to frame-to-frame registration and need to be removed to accurately align frames for use further downstream for target detection, tracking etc., in the automated exploitation pipeline.

Presence of burn-ins also adversely affects background modeling in video exploitation systems. Accurate background modeling is necessary in order to identify the foreground areas of the image for performing detection and tracking in the automated video exploitation pipeline. The background is typically learned or modeled from the images and frames are differenced to perform background subtraction to identify moving areas of the image as motion-blobs. Blob detection refers to detecting regions in a digital image that differ in properties such as brightness or color, compared to the surrounding region. Some of the burn-ins are often dynamic. For example, the North direction marker and arrow move around the image as the camera moves during acquisition. The instrument readings displayed as burn-ins, location co-ordinates etc., are constantly changing in the full-motion video. This interferes with background modeling and furthermore when frame-differencing is done to subtract the background, these changes can cause spurious motion blobs which give rise to numerous false alarms and errors. Thus burn-ins are an impediment to background modeling/background subtraction and so they need to be removed in order to accurately perform target detection, tracking etc., in the automated video exploitation pipeline.

In a further example, metadata symbology is often burnt into aerial imagery that are to be reviewed by analysts. Burn-ins from sensitive data generally needs to be redacted. Current systems simply black out these areas by super-imposing black boxes over the burn-ins. However, automatic target detection, tracking, and recognition algorithms find the resulting redacted images challenging and prone to false detections and similar errors due to the artificial edges and corners introduced by the black boxes. This impediment is currently being addressed by blocking out the overlay areas from being processed instead of physically removing the overlays. Therefore, it is not typically feasible to utilize this existing solution with video exploitation systems to process the entire image content properly.

Wherefore it is an object of the present disclosure to overcome the above-mentioned shortcomings and drawbacks associated with the conventional full motion video imagery processing.

### SUMMARY OF THE DISCLOSURE

One aspect of the present disclosure is A method for removal of burn-in data from full motion video imagery, comprising: identifying one or more burn-in overlay areas in a full motion video image; creating a mask of the one or more burn-in overlay areas, the mask comprising a plurality of pixels; dilating the mask; feeding at least a portion of the dilated mask into a pixel replacing section, wherein the portion comprises the one or more burn-in overlay areas and a plurality of neighboring pixels proximate the one or more burn-in overlay areas; creating matched intensities for the plurality of pixels in the portion of the dilated mask based on a plurality of neighboring pixels; and replacing the one or more burn-in overlay areas by filling the plurality of pixels in the one or more burn-in overlay areas with matched intensities to form a resultant image.

One embodiment of the method further comprises running the resultant image through a video processing to obtain one or more detections.

Another embodiment of the method is wherein the resultant image is prepared for a video processing step in real time.

Yet another embodiment of the method is wherein the mask is created using a color space decomposition method. In some cases, generated via a color-space decomposition begin by converting an RGB image into YCbCr color space. In certain embodiments, a binary mask is created. In some embodiments, the binary mask is fed into the in-painting algorithm.

Still yet another embodiment of the method is wherein automatically substituting one or more burn-in areas with matched pixels is via in-painting and order-filtering. In some cases, in-painting is used in a center portion of the full motion video image and order-filtering in used on a periphery of the full motion video image.

Another aspect of the present disclosure is a computer program product including one or more non-transitory machine-readable mediums having instructions encoded thereon that, when executed by one or more processors, cause a process to be carried out for removal of burn-in from full motion video imagery, the process comprising: identifying one or more burn-in overlay areas in a full motion video image; creating a mask of the one or more burn-in overlay areas, the mask comprising a plurality of pixels; dilating the mask; feeding at least a portion of the mask into an in-painting algorithm; creating matched intensities for the plurality of pixels in the mask based on neighboring unmasked pixels; removing the one or more burn-in overlay areas by filling the plurality of pixels in the mask with matched intensities to form a resultant image; and running the resultant image through a video process to obtain one or more detections.

One embodiment of the computer program product is wherein the resultant image is prepared for a video processing step in real time.

Another embodiment of the computer program product is wherein the mask is created using a color space decomposition method. In some cases, masks generated via a color-space decomposition begin by converting an RGB image into YCbCr color space. In some cases, a binary mask is created. In certain embodiments, the binary mask is fed into the in-painting algorithm.

Yet another embodiment of the computer program product is wherein automatically substituting one or more burn-in areas with matched pixels is via in-painting and order-filtering. In certain embodiments, in-painting is used in a center portion of the full motion video image and order-filtering in used on a periphery of the full motion video image.

Yet another aspect of the present disclosure is a method for removal of burn-in from full motion video imagery, comprising: identifying one or more burn-in overlay areas in a full motion video image; creating a mask of the one or more burn-in overlay areas, the mask comprising a plurality of pixels; dilating the mask; feeding at least a portion of the mask into an in-painting algorithm; creating matched intensities for the plurality of pixels in the mask based on neighboring unmasked pixels, wherein in-painting is used in a center portion of the full motion video image and order-filtering in used on a periphery of the full motion video image to create the matched intensities; removing the one or more burn-in overlay areas by filling the plurality of pixels in the mask with matched intensities to form a resultant image; and running the resultant image through a video processing step to obtain one or more detections.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure. The patent or application file contains at least one drawing executed in color. Copies of this patent or patent application publication with color drawing(s) will be provided by the Office upon request and payment of the necessary fee.

FIG. 1 shows an image of full motion video prior to burn-in removal according to one embodiment of the present disclosure.

FIG. 2A and FIG. 2B show color-space masks applied to the image of full motion video in FIG. 1 prior to burn-in removal according to one embodiment of the present disclosure.

FIG. 3 shows a binarized mask of the image of full motion video from FIG. 2A or FIG. 2B prior to burn-in removal according to one embodiment of the present disclosure.

FIG. 4A and FIG. 4B show a morphological process being applied to the image form FIG. 3 to dilate a mask for burn-in removal from a full motion video image according to one embodiment of the present disclosure.

FIG. 5 shows the geodesic-distance map of full motion video image from FIG. 4B prior to burn-in removal, wherein neighborhood pixels contribute image information into masked areas according to one embodiment of the present disclosure.

FIG. 6 shows the image of full motion video after burn-in removal according to one embodiment of the present disclosure.

FIG. 7 is a flowchart of a method of removing burn-in from full motion video imagery as a pre-processing step according to one embodiment of the present disclosure.

### DETAILED DESCRIPTION OF THE DISCLOSURE

In contrast to existing solutions, one embodiment of the present disclosure replaces burn-ins in full motion video (FMV) imagery with matched image information from neighboring pixels, thus erasing out the burn-in overlay portions of the image with matching information that is consistent with surrounding image areas. The replacement of burn-in pixels being consistent with surrounding image areas is crucial as this precludes spurious edges or corners from being formed, thus preventing the possibility that any false detections may occur during automated feature extraction by the video exploitation algorithms. The resulting image (with burn-in removed) is then amenable for further automated processing (the resulting image is a pre-processing step) or viewing by analysts for manual exploitation/processing. In contrast to prior methods, the resulting image, as described herein, is useful in its entirety, as it appears seamlessly filled in.

Prior systems used black boxes to “redact” burn-in information. A better alternative, as used herein, is to inpaint burn-in areas with image information from neighborhood pixels. This makes the resulting image visually more appealing and provides an additional benefit for downstream processing of the resulting images via automated detection and tracking algorithms, or the like.

One embodiment of the system and method for burn-in removal from FMV imagery for video exploitation automatically identifies and replaces burn-in areas in the FMV imagery. Furthermore, the system may be used as a pre-processing step in an automated video processing pipeline. One embodiment of the method of burn-in removal from FMV imagery for video processing involves the following steps: (i) automatically identifying burn-in areas to create a mask via a color space decomposition method (ii) automatically substituting burn-in areas by filling masked pixels with intensities matched to their neighboring unmasked areas via image in-painting and order-filtering, and (iii) integrating this process into existing video exploitation/processing pipeline as a pre-processing step.

It is to be understood that the technique of the present disclosure is useful in forensic situations and/or in scenarios where add-on capabilities such as automated detection, tracking, and target recognition are needed in addition to manual viewing. The present technique can also be used to create data test sets from data with burn-ins. Certain embodiments of the present disclosure are useful for the defense industry and/or law enforcement use where removal of meta-data information burned into video image data is needed so that analysts may extract intelligence products and/or exploit information in the imagery via automated systems for registration, tracking, scene analysis, machine learning, knowledge acquisition purposes, and the like. Other embodiments of the present disclosure may be useful for general commercial use, where whole or parts of this disclosure may be useful for removal of text overlay from video clips such as subtitles, logos, and watermarks.

One embodiment of the removal of burn-in from full motion video imagery of the present disclosure (i) identifies burn-in overlay areas to create a mask, (ii) removes the overlay by filling masked pixels with intensities matched to their neighboring unmasked areas and (iii) subsequently runs the images through the video processing to obtain successful detections. In some cases, the detections are vehicles, living creatures, or other areas/items of interest.

In one embodiment, one step for removal of burn-in from full motion video imagery is to identify the areas of an image with burn-in overlays and create a binary mask of these areas, so that the binary mask may be used by an in-painting algorithm, or the like, to determine which areas need to be filled in. In one embodiment, masks are generated via a color-space decomposition method where the first step is converting an RGB image to YCbCr color space. In YCbCr format, luminance information is stored as a single component (Y), and chrominance information is stored as two color-difference components (Cb and Cr). The Cb channel represents the difference between the blue component and a reference value. The Cr channel represents the difference between the red component and a reference value. Given a digital pixel represented in RGB format, 8 bits per sample, where 0 and 255 represents the black and white color, respectively, the YCbCr components can be obtained according to equations (1) to (3):

$$\{ \begin{matrix}Y = 16 + \frac{65.738 R}{256} + \frac{129.057 G}{256} + \frac{25.064 B}{256} & ( 1 ) \\ Cb = 128 - \begin{matrix}37.945 R \\ 256\end{matrix} - \begin{matrix}74.494 G \\ 256\end{matrix} + \begin{matrix}112.439 B \\ 256\end{matrix} & ( 2 ) \\ Cr = 128 + \frac{112.439 R}{256} - \frac{94.154 G}{256} - \frac{18.285 B}{256} & ( 3 )\end{matrix}$$

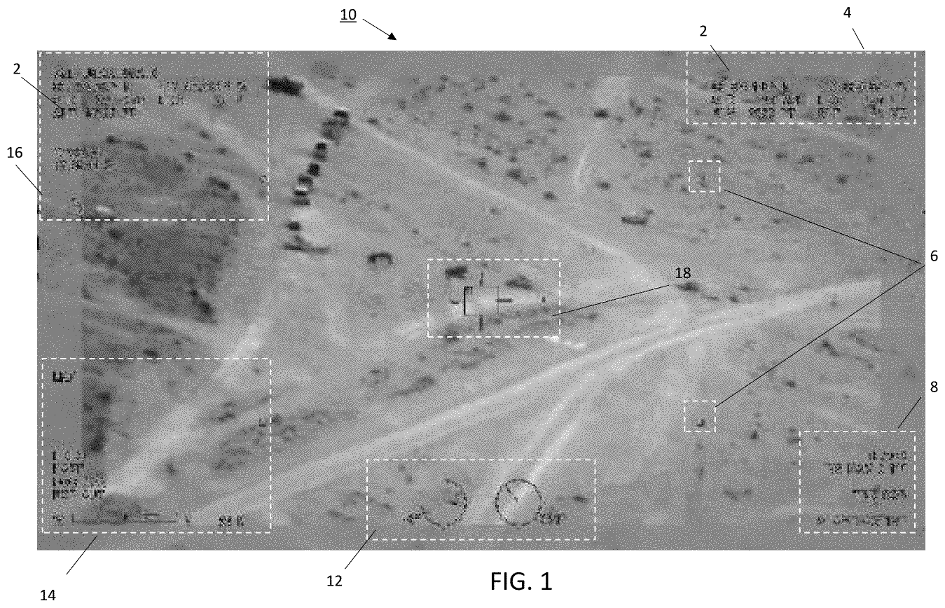

Referring to FIG. 1, an image of full motion video 10 prior to burn-in removal according to one embodiment of the present disclosure is shown. More specifically, this image is a given image with the burn-in data selected 2 shown as green. This burn-in data in one example represents sensitive data that needs to be removed but without compromising the underlying image. The burn-in data can also be information about the image such as data provided to an operator, but which negatively impacts the computer vision processing for automated identification and tracking. White dotted lines boxes indicate areas of burn-in overlays, e.g., 4, 6, 8, 12, 14, 16, 18. As noted, the boxes can vary in size depending upon the extent of the burn-in data and is intended to include the burn-in content in a given region.

Still referring to FIG. 1, the size of the box in one example is simplified and larger boxes are used to capture separated burn-in data that is within a box such as shown in the region box 16. In another example, the boxes can be defined with smaller boxes (6, 8) that capture smaller portions of the burn-in data. While shown as squares and rectangles, the boxes can be other shapes as long as the burn-in content is captured within the region. In one embodiment, identification of the burn-in overlay area involves mask formation, which includes thresholding the Cr component with a pre-determined value for binarization.

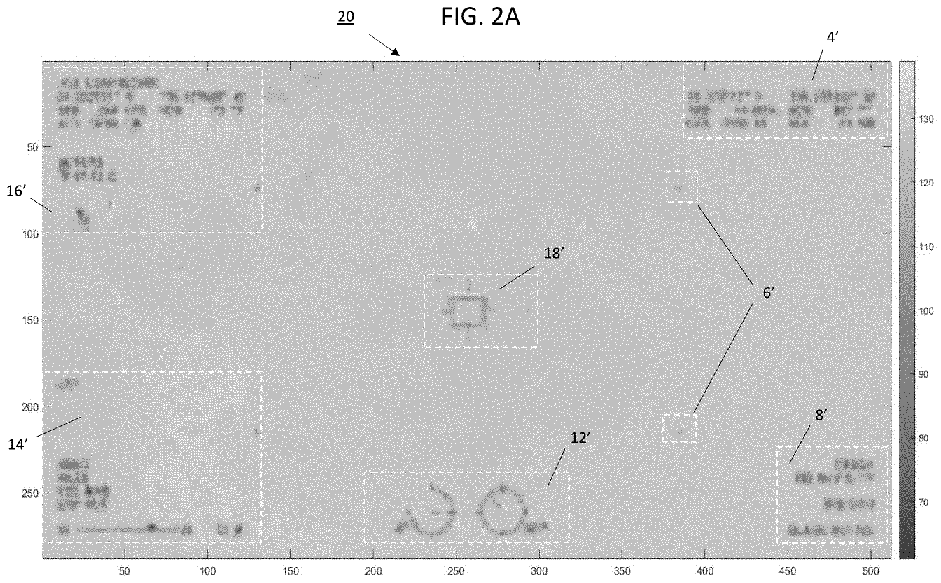

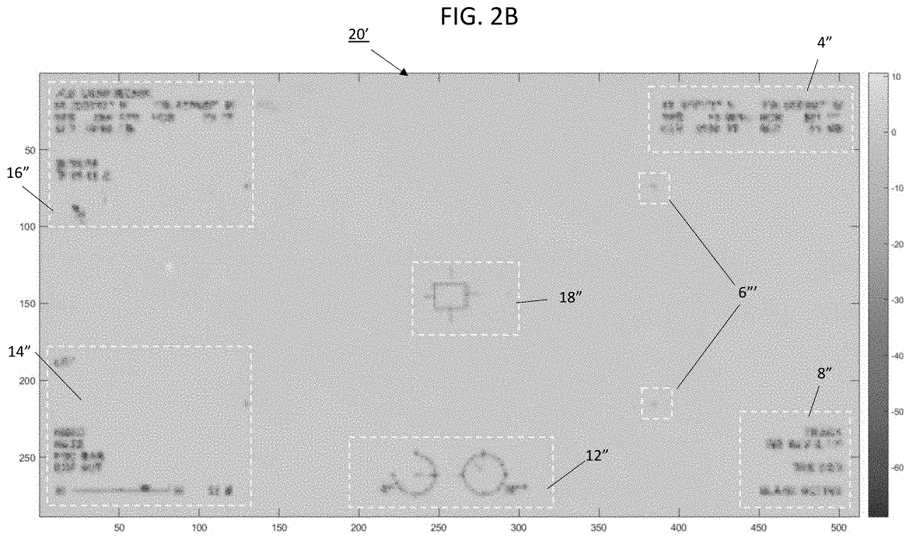

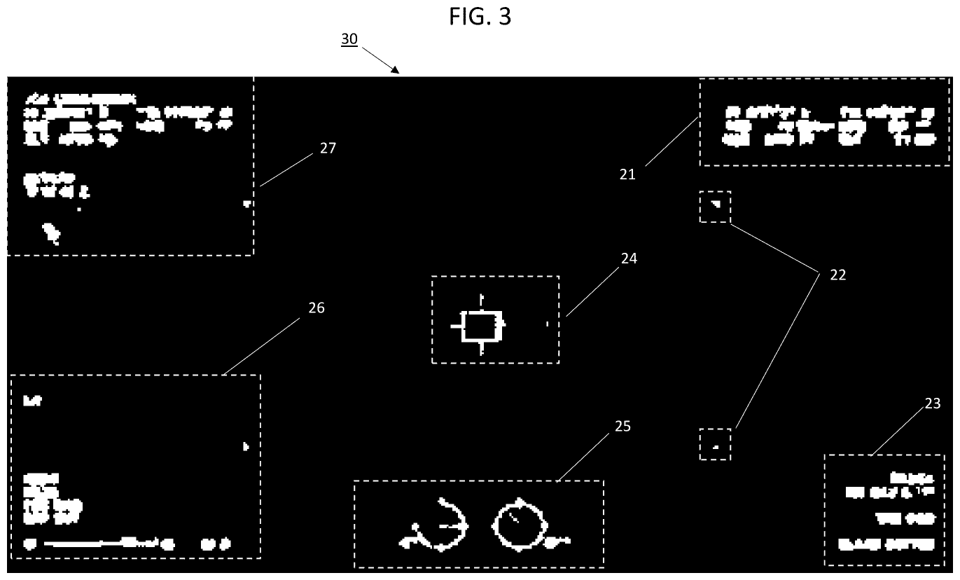

Referring to FIG. 2A, an image of full motion video 20 with masks of overlay areas and prior to burn-in removal according to one embodiment of the present disclosure is shown. More specifically, the Cr chrominance channel of the original image (from FIG. 1) has been converted from RGB to YCbCr color space and is shown where the burn-in overlay areas in boxes 4′, 6′, 8′, 12′, 14′, 16′ 18′, stand out in cyan against a yellow background. The Cr component of the YCbCr color space highlights the burn-in areas in contrast to the remaining actual image areas. Therefore, suitably thresholding the Cr channel of the YCbCr image enables a binary mask of the burn-in areas to be formed (See, e.g., FIG. 3) to distinguish the burn-in areas from the underlying image areas.

A threshold value is decided by the chrominance range of the burn-in areas highlighted in the Cr component image. In FIG. 2A, on the right-hand side a color-bar has been plotted adjacent to the image of the Cr channel of the YCbCr color space image. In this embodiment, the color-bar indicates that any chrominance values about 120 and under belong to the burn-in areas while any higher values belong to actual image areas. It is possible to use other color spaces for finding the mask, such as the LAB color space (as shown in FIG. 2B).

Referring to FIG. 2B, an image of full motion video 20′ with masks and prior to burn-in removal according to one embodiment of the present disclosure is shown. More specifically, the A channel of the original image (from FIG. 1) has been converted from RGB to LAB color space and is shown where the burn-in overlay areas stand out in cyan against a yellow background and are within boxes 4″, 6″, 8″, 12″, 14″, 16″ 18″. Here, the A-channel of the LAB image was thresholded at −5 to get the mask as indicated by the color-bar in FIG. 2B. Above techniques are embodiments of the color decomposition process. The threshold value may vary in various cases depending on the RGB color intensity of the burn-ins present in the imagery. It is also possible to automate the threshold selection.

Referring to FIG. 3, a binarized mask 30 for the image of full motion prior to burn-in removal according to one embodiment of the present disclosure is shown. More specifically, here burn-in areas previously identified by thresholding (See, e.g., FIG. 2A or FIG. 2B) are then selected to be highlighted on the image in boxes 21-27. The burn-in masked areas are highlighted in white and show the final mask of the burn-in areas as a binary image for later processing steps.

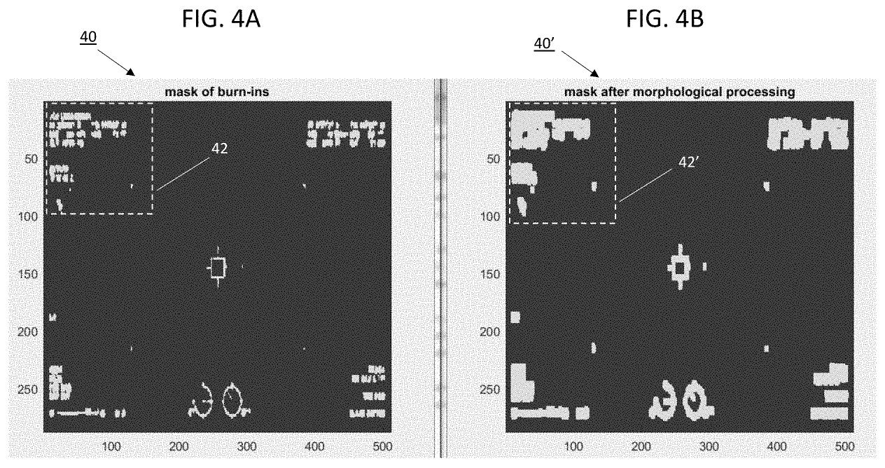

Referring to FIG. 4A and FIG. 4B, a morphological process is shown being applied to dilate a mask for burn-in removal from full motion video imagery according to one embodiment of the present disclosure. More specifically, a binary mask 40 is shown in FIG. 4A prior to an expansion/blurring/smoothing step as shown in FIG. 4B 40′. The binary mask image is akin to that of FIG. 3. In some cases, the expansion/blurring/smoothing applied to the image is in the form of dilation. Dilation adds pixels to the mask area boundaries using a structuring element. The size and shape of the structuring element can vary. In some embodiments, square structuring element of dimension 5 were used. The structuring element sizes recommended for color decomposition masking are 3, 5 or 7 and square shape better suits the nature of the burn-in areas due to presence of text and numbers. In certain embodiments, a cumulative mean mask and two dilation steps in GIMP (GNU Image Manipulation Program) yielded the mask shown in FIG. 4B. Looking at the dashed box region 42 in FIG. 4A and then the same boxed region 42″ in FIG. 4B it is clear that there has been some spread/dilation to the burn-in data within the masked area. This dilation step helps to ensure that the area to be masked, i.e., where text or other burn in ends and the image begins, is accounted for and is complete.

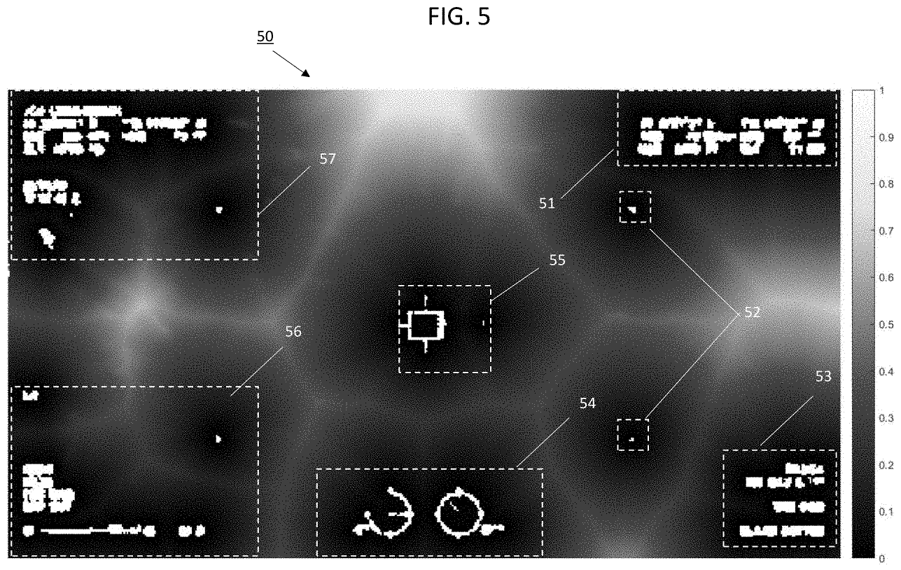

Referring to FIG. 5, the geodesic distance map 50 of the masked full motion video image prior to burn-in removal, wherein neighborhood pixels contribute image information to masked areas according to one embodiment of the present disclosure, is shown. The processing described herein is used to generate the underlying video image that is obscured by the burn-in data so that the underlying images may be used in the automated detection and tracking processing. The pixels shown as darker areas immediately surrounding the white burn-in mask areas are weighted proportionately more heavily than the farther away lighter red and yellow areas while computing the weights contributing to the in-fill intensity. Here the white burn-in mask areas are shown within dashed boxes (e.g., 51-57) for clarity of labeling and discussion.

In certain embodiments, in-painting intensity of a pixel p is determined by the values of the known pixels close to p. That contribution is proportional to the distance of the neighbor pixels as determined by summing the estimates of all pixels q in the neighborhood, weighted by a normalized weighting function. A weighting function takes into account image gradient as well as distances from p. In some cases, this is an in-painting technique (e.g., Telea in-painting) moving across the pixel's neighborhood based on an iterative algorithm, e.g., FMM (fast marching method). While the in-painting techniques in general are capable of handling color images, for our purposes the image was converted from RGB to grayscale ahead of in-painting, as the video exploitation systems in general utilize grayscale imagery.

In certain embodiments, the processing time for a color-space decomposition process to create the mask is one-third of the time that it takes for other methods such as image decomposition that use FFT (fast Fourier transform). In one embodiment, the average time was ˜0.04 seconds for the former versus ˜0.13 seconds for the latter. It is to be noted that for the existing video exploitation systems to be able to successfully use this pre-processing step, the pre-processing should be completed within certain frame rate constraints of the system. So, the faster method employing the color-space decomposition detailed herein is preferable over slower methods.

To remove burn-in overlay areas, according to one embodiment of the present disclosure, masked pixels (i.e., white areas within the white dashed boxes in FIG. 5) are filled in with intensities matched to neighboring image patches, thus replacing the burn-in overlay pixel intensities. In some cases, two different techniques are used for this. In one embodiment, the mask areas corresponding to the center portion of the image 55 (which typically contains targets or areas of interest) is precision-filled using an in-painting technique, while peripheral portions of the mask (e.g., 53) are fast-filled using an order-filtering technique. The reason for using two different techniques is so that the fill operation is done rapidly enough to facilitate real-time processing of the full motion video images for further video processing.

While in-painting provides a better image quality result, it is a time-consuming operation. That is why, in certain embodiments, it is restricted to the center portion of the frame. Order filtering, on the other hand, results in coarser filled areas but it is a much faster operation. Having a coarser fill in background areas where there are no moving targets and having a finer fill in areas wherein targets of interest would lie works well for real-time processing. In one embodiment, an average time taken for in-painting was ˜2 to ˜2.5 seconds per entire frame. When in-painting is restricted to the center of the image (e.g., center ¼^{th} to ¾^{th} for 1280×720 image) it takes less than 0.6 seconds.

In one embodiment, the Telea in-painting algorithm was used. The Telea algorithm estimates the value of a pixel to be in-painted based on a neighborhood of known pixels around it. In certain embodiments, a FMM algorithm was then used to determine the order in which border pixels are in-painted, i.e., from the least distance to known pixels to greatest, to reduce the in-painting area in size as the algorithm progresses. In one embodiment, the algorithm starts from the boundary of the known neighborhood region and moves inside the mask region gradually to fill from the boundary first. It takes a small neighborhood around the pixel to be in-painted. This pixel is replaced by the normalized weighted sum of all the known pixels in the neighborhood. In some cases, the algorithm gives more weight to neighboring pixels near the point to be in-painted, near to the normal of the boundary, and those lying on the boundary contours. Still referring to FIG. 5, the geodesic distance map of the masked original image shows the pixels as darker areas immediately surrounding the white burn-in mask areas and they are weighted proportionately more heavily than the farther away lighter areas (reds, etc.) in contributing to the in-painting fill intensity.

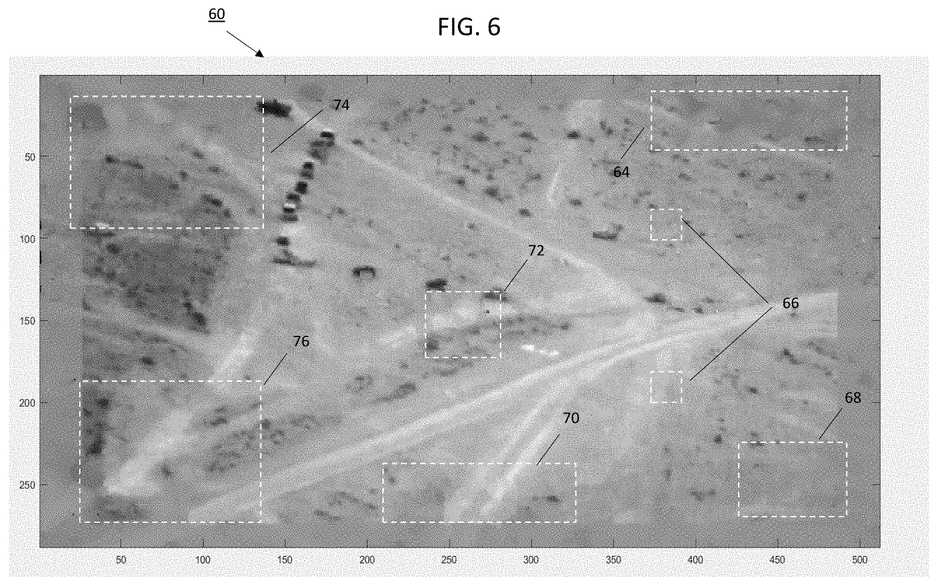

Referring to FIG. 6, the image 60 of full motion video after burn-in removal according to one embodiment of the present disclosure is shown. More specifically, FIG. 6 shows the result of applying the process, including an in-painting algorithm on the given original image shown in FIG. 1, where the in-painting process has replaced all the overlay pixels with matched intensities. This results in an image that appears to be complete, but that no longer contains burn-in overlay areas that would be an impediment to downstream processing. See, e.g., boxes 64, 66, 68, 70, 72, 74, and 76, where the image has been approximated and is free of burn-in data.

Certain embodiments of burn-in removal from full motion video imagery for video exploitation used an order-filtering algorithm for a fast-fill process with which peripheral areas of the mask were filled. The algorithm was provided an ‘order’ parameter and a ‘domain’ parameter which indicates the neighborhood to be filled. Order filtering replaces each element in the given neighborhood by the ‘order’^{th} element in the sorted set of neighbors specified by nonzero elements in the domain. For example, the operation ordfilt2(A, 5, ones (3,3)) uses a 3×3 domain and orders the nine (9) pixel intensity values in the neighborhood in ascending order. It then replaces every pixel in the domain by the 5^{th} element in the order. This example is the same as median filtering since the 5^{th} element is the median value. One embodiment of the order filter allows a choice of a different element in the order, which is not necessarily the median.

Still referring to FIG. 6, the result of the combination of the order filtering and in-painting algorithms applied to the image shown in FIG. 1, is shown. There, the in-painting process replaced all the central overlay pixels (e.g., those within a mask within 72), and the peripheral areas were order filtered (e.g., those within a mask within 64, 68 . . . ). Here, an order of 100 and a domain of 15×15 was used. The order filtering operation took on an average ˜0.24 seconds, bringing the total processing time for each frame to under a second. Since this technique is often used as a pre-processing step, it was verified that the video processing was in fact able to detect a target on the in-painted and order-filtered resultant image.

The average time taken per frame for forming the mask was ˜0.04 seconds. The total average time taken for the in-painting, order-filtering, and combining operations was ˜0.83 seconds. Thus, total processing time per frame was under a second per frame for one embodiment. Typically, once this type of process is ported to C++ there is an order of ten speedup, which brings the processing time per frame to under a tenth of a second. If a video processing system processes video at about 6 Hz, this order of timing should be acceptable for real-time operation.

The C++ implementation operated at 30 to 38 frames per second on 1024×768 resolution imagery. The implementation made use of the open-source image processing library OpenCV. Porting from MATLAB to C++ was straightforward, but the algorithm required small changes for C++ and for use in a video processing chain. A suitable order filter function was not available, so a median filter fast-filled the image periphery instead. However, the median filter resulted in black areas in solid portions of the mask where the masked areas were larger than the kernel size. To fix this issue, the median filter ignored pixels within the mask when calculating the neighborhood average by applying filtering to both the mask and image, and then dividing the filtered image by the filtered mask. Additionally, to avoid erroneously in-painting large portions of an image, the C++ implementation skipped in-painting if the percentage of pixels detected as the mask was over a parameterized threshold.

This disclosure has shown that: (a) the color space decomposition method can successfully identify burn-in overlays; (b) the masked overlay areas can be successfully filled using a combination of in-painting and order filtering methods in under a second per frame and (c) the video processing is able to successfully detect on the in-painted imagery with sufficient quality for the detections to subsequently be used for track stitching.

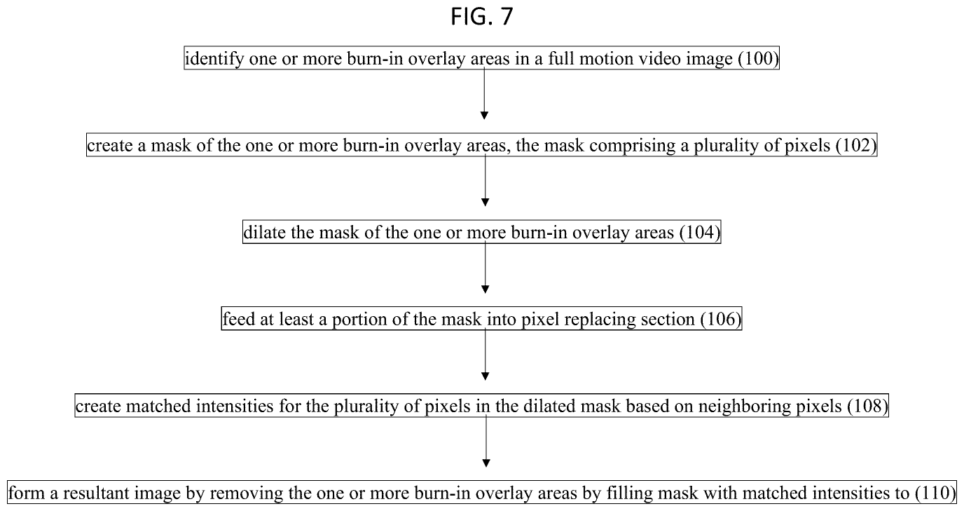

Referring to FIG. 7, a flowchart of a method of removing burn-in from full motion video according to one embodiment of the present disclosure is shown. More specifically, the system identifies one or more burn-in overlay areas in a full motion video image 100. The burn-in overlay areas represent regions having burn-in data that was placed onto the image. The regions capture one or more burn-in data elements and can be a plurality of pixels making up boxes or other shapes such as oval or circles. The size of the area can vary depending upon specific parameters and the space between respective burn-in data items. The processing creates a mask of the one or more burn-in overlay areas 102 in the image. The mask comprises a plurality of pixels for the one or more burn-in areas. The pixels within the burn-in overlay area contains the burn-in data that occupies the overlay area pixels that originally may have had image data but was later over-written by the burn-in data. In certain embodiments, the mask is generated via a color-space decomposition method. In some cases, by converting an RGB image into YCbCr color space. In some cases, the mask is then converted into a binary mask. In certain embodiments, the binary mask is dilated 104, or otherwise blurred or expanded. Dilation refers to adding pixels to the mask area boundaries using a structuring element. The size and shape of the structuring element can vary.

Still referring to FIG. 7, at least a portion of the dilated mask is then fed into a pixel replacing section 106. The pixel replacing section utilizes an order-filtering processing, in-painting processing, or a combination of order-filtering for certain pixels and in-painting for other pixels. For pixels that represent a static background, the order-filtering tends to be faster whereas for pixels that represent moving objects, the in-painting processing tends to generate better quality. Matched intensities for the plurality of pixels in the dilated mask, or overlay area replacing the burn-in data are created using neighboring pixels 108. The dilated mask refers to the burn-in overlay region as well as some neighboring pixels that represent pixels that may not have burn-in data but are in close proximity to the burn-in data and so they are selected in the mask so that no burn-in data is left unprocessed. The matched intensities are selected as shown in FIG. 5. The one or more burn-in overlay areas are replaced by filling the plurality of pixels within the dilated mask, or the like, with matched intensity pixels to form a resultant image 110. The resultant image represents the starting video image with the burn-in data replaced by an estimation of the original image based on the pixel replacement processing. In certain embodiments, the resultant image may then be run through a video processing step to obtain one or more detections. The detections in one example refer to target detection such as a building or vehicle in the image. For example, if there was a convoy of vehicles, the tracking detection could isolate a particular vehicle through moving video.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached, or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A method for removal of burn-in data from full motion video imagery, comprising:
identifying one or more burn-in overlay areas in a full motion video image;
creating a mask of the one or more burn-in overlay areas, the mask comprising a plurality of pixels;
dilating the mask;
feeding at least a portion of the dilated mask into a pixel replacing section, wherein the portion comprises the one or more burn-in overlay areas and a plurality of neighboring pixels proximate the one or more burn-in overlay areas;
creating matched intensities for the plurality of pixels in the portion of the dilated mask based on a plurality of neighboring pixels; and
replacing the one or more burn-in overlay areas by filling the plurality of pixels in the one or more burn-in overlay areas with matched intensities to form a resultant image.

2. The method according to claim 1, further comprises running the resultant image through a video processing to obtain one or more detections.

3. The method according to claim 1, wherein the resultant image is prepared for a video processing step in real time.

4. The method according to claim 1, wherein the mask is created using a color space decomposition method.

5. The method according to claim 4, wherein masks generated via a color-space decomposition begin by converting an RGB image into YCbCr color space.

6. The method according to claim 1, wherein automatically substituting one or more burn-in areas with matched pixels is via in-painting and order-filtering.

7. The method according to claim 6, wherein in-painting is used in a center portion of the full motion video image and order-filtering in used on a periphery of the full motion video image.

8. The method according to claim 1, wherein a binary mask is created.

9. The method according to claim 8, wherein the binary mask is fed into the in-painting algorithm.

10. A computer program product including one or more non-transitory machine-readable mediums having instructions encoded thereon that, when executed by one or more processors, cause a process to be carried out for removal of burn-in from full motion video imagery, the process comprising:
identifying one or more burn-in overlay areas in a full motion video image;
creating a mask of the one or more burn-in overlay areas, the mask comprising a plurality of pixels;
dilating the mask;
feeding at least a portion of the mask into an in-painting algorithm;
creating matched intensities for the plurality of pixels in the mask based on neighboring unmasked pixels;
removing the one or more burn-in overlay areas by filling the plurality of pixels in the mask with matched intensities to form a resultant image; and
running the resultant image through a video process to obtain one or more detections.

11. The computer program product according to claim 9, wherein the resultant image is prepared for a video processing step in real time.

12. The computer program product according to claim 9, wherein the mask is created using a color space decomposition method.

13. The computer program product according to claim 11, wherein masks generated via a color-space decomposition begin by converting an RGB image into YCbCr color space.

14. The computer program product according to claim 9, wherein automatically substituting one or more burn-in areas with matched pixels is via in-painting and order-filtering.

15. The computer program product according to claim 13, wherein in-painting is used in a center portion of the full motion video image and order-filtering in used on a periphery of the full motion video image.

16. The computer program product according to claim 9, wherein a binary mask is created.

17. The computer program product according to claim 15, wherein the binary mask is fed into the in-painting algorithm.

18. A method for removal of burn-in from full motion video imagery, comprising:
identifying one or more burn-in overlay areas in a full motion video image;
creating a mask of the one or more burn-in overlay areas, the mask comprising a plurality of pixels;
dilating the mask;
feeding at least a portion of the mask into an in-painting algorithm;
creating matched intensities for the plurality of pixels in the mask based on neighboring unmasked pixels, wherein in-painting is used in a center portion of the full motion video image and order-filtering in used on a periphery of the full motion video image to create the matched intensities;
removing the one or more burn-in overlay areas by filling the plurality of pixels in the mask with matched intensities to form a resultant image; and
running the resultant image through a video processing step to obtain one or more detections.
